(19) United States
(12) Patent Application Publication
(10) Pub. No.: US 2025/0289377 A1
(43) Pub. Date: Sep. 18, 2025

(54) INSULATING ELEMENT

(71) Applicant: SIKA TECHNOLOGY AG, Baar (CH)

(72) Inventor: Heinz ETTERLI, Besenbüren (CH)

(73) Assignee: SIKA TECHNOLOGY AG, Baar (CH)

(21) Appl. No.: 18/861,254

(22) PCT Filed: Feb. 3, 2023
(86) PCT No.: PCT/EP2023/052647

§ 371 Date: Oct. 29, 2024

(30) Foreign Application Priority Data
May 3, 2022 (EP) 22171372.0

(51) Int. Cl. B60R 13/08; B62D 29/00

(52) U.S. Cl. CPC B60R 13/0815; B62D 29/002

(57) ABSTRACT

An insulating element for insulating a structural element in a motor vehicle includes a carrier and at least one elongated expansion element. The carrier has at least one fixing element for fixing of the carrier to the structural element, and also at least one receiving element. The elongated expansion element includes expandable material, and the expansion element is mounted on the receiving element of the carrier.

The invention relates to an insulating element for insulating a structural element in a motor vehicle.

In many cases, components such as, for example, vehicle bodies and/or frames of means of transport and locomotion, especially of water or land vehicles or of aircraft, have structures with cavities in order to enable lightweight constructions. However, these cavities cause a wide variety of problems. Depending on the type of the cavity, the latter has to be sealed in order to prevent the ingress of moisture and soiling, which can lead to corrosion of the components. It is often also desirable to substantially reinforce the cavities and hence the component, but to maintain the low weight. It is often also necessary to stabilize the cavities and hence the components, in order to reduce noise which would otherwise be transmitted along or through the cavity. Many of these cavities have an irregular shape or a narrow extent, which makes it more difficult to seal, reinforce and insulate them properly.

Especially in automotive construction, but also in aircraft construction and boatbuilding, sealing elements (baffles) are therefore used in order to seal and/or acoustically insulate cavities, or reinforcing elements (reinforcers) are used in order to reinforce cavities.

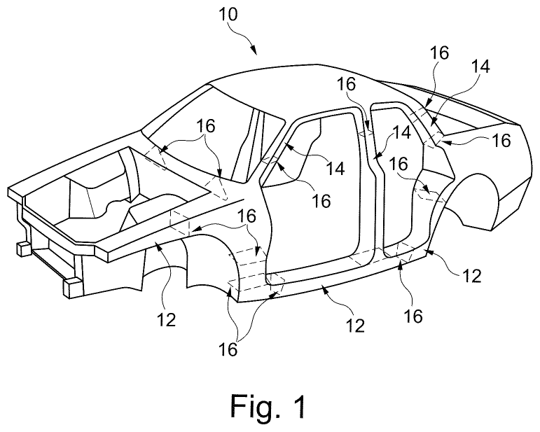

FIG. 1 is a schematic diagram of a body of an automobile. The vehicle body 10 here has various structures with cavities, for example pillars 14 and beams or crossbeams 12. Such structural elements 12, 14 with cavities are typically sealed and/or reinforced using sealing elements and reinforcing elements 16 respectively.

It is a disadvantage of the previously known sealing and/or reinforcing elements that, for each vehicle body shape and for each cavity of a vehicle body, an individually adapted element has to be produced. This results in high development and production costs and is disadvantageous in particular in the case of relatively small vehicle production runs.

It is therefore an object of the present invention to provide an improved insulating element for insulating a structural element in a motor vehicle, which avoids the drawbacks of the prior art. The insulating element is intended to give rise in particular to economic advantages in the case of small production runs and to reduce the development and production complexity of the insulating elements overall.

This object is achieved by an insulating element for insulating a structural element in a motor vehicle, the insulating element comprising: a carrier having at least one fixing element for fixing of the carrier to the structural element and at least one receiving element; and at least one elongated expansion element with expandable material, where the expansion element is being mounted on the receiving element of the carrier.

A core concept of the present invention is in particular that the use of modular components (carrier and expansion elements) can create a multitude of different insulating elements with which a multitude of differently shaped cavities can be insulated. In this case, it is not necessary to design a new insulating element for each new application, which typically incurs high costs because new injection molds are required each time. The use of carriers and expansion elements that can be assembled individually allows the same modules to be used time and again for different applications.

Especially in the case of small production runs or other applications with a small number of items, it is often not worthwhile to manufacture separate injection molds for specific insulating elements. The use of standardized modules, especially of the expansion elements, can provide inexpensive solutions for such applications.

In the context of this invention, the term “insulating element” or “insulation” or “insulated” covers elements or structures or method steps for partitioning off and/or occluding and/or insulating a structural element. These different characteristics of such an insulating element may occur individually or in combination with one another.

In one illustrative embodiment, the expansion element has been produced by an extrusion method.

The use of an extrusion method for production of the expansion elements has the advantage that it is possible in this way to produce various expansion elements by one production process or with one production apparatus. For example, a cross section of the elongated expansion elements may be varied, or else a length of the elongated expansion elements may be varied. In this way, depending on the application, it is possible to provide various expansion elements.

In one illustrative embodiment, the expansion element has been formed solely from expandable material.

In an alternative embodiment, the expansion element comprises an insert in the form of a foil or ribbon, where said insert has been covered on both sides by expandable material.

In one illustrative development, the insert is completely surrounded by expandable material.

In one illustrative development, the insert is a metal foil or a metal ribbon, especially a steel foil or a steel ribbon.

In one illustrative development, the insert is disposed essentially in the middle of the expansion element.

In one illustrative embodiment, the expansion element has one or two or more than two holes.

The provision of such holes has the advantage that this allows the attachment of the expansion elements to the carrier to take place more easily. Especially in the case of expansion elements with inserts, it is advantageous when the expansion elements have holes through which the receiving element of the carrier can be conducted.

In one illustrative development, the hole(s) has/have an elongated outline.

The provision of an elongated hole has the advantage that, in the case of embodiments having two or more holes and two or more receiving elements, the distances between the holes are less tolerance-critical.

In one illustrative embodiment, the expandable material has an expansion rate between 1000% and 4000%, especially between 1500% and 3000%.

In one illustrative embodiment, the carrier has one or two fixing elements.

In one illustrative development, the fixing element(s) take(s) the form of a clip or of a pushpin.

In one illustrative embodiment, the carrier has one or two or more than two receiving elements.

In one illustrative embodiment, the carrier has been produced by an injection molding method.

In one illustrative embodiment, the at least one receiving element has a barbed hook at one free end.

Such barbed hooks have the advantage that the attached/mounted expansion elements are incapable or essentially incapable of dropping off the receiving element.

In one illustrative embodiment, just one expansion element is being mounted on each receiving element.

In an alternative working example, between two and eight expansion elements are being mounted on each receiving element, especially between two and six expansion elements, and especially between two and four expansion elements.

In one illustrative embodiment, the carrier comprises two fixing elements and two receiving elements. Between two and eight expansion elements are being mounted on to these two receiving elements, where each of these expansion elements are being mounted on to both receiving elements of the carrier.

Such a configuration of an insulating element has the advantage that this allows expansion elements to form, following expansion, a material expanded in the form of a wall, which is of very good suitability for insulating cross sections in structural elements. Because the expansion elements have been attached to/mounted on the receiving elements in a movable manner, this achieves the effect that the expansion elements or the expandable material can move along the receiving elements during an expansion. This achieves very significant expansion of the expandable material in the direction of the receiving elements, which allows very efficient insulation of a cross section.

### Expandable Material

The expandable material used may in principle be various materials that can be made to foam. This material may or may not have reinforcing properties. Typically, the expandable material is made to expand thermally, by moisture or by electromagnetic radiation.

Such an expandable material typically has a chemical or a physical blowing agent. Chemical blowing agents are organic or inorganic compounds which decompose under the influence of temperature, moisture or electromagnetic radiation, where at least one of the decomposition products is a gas. Physical blowing agents used may, for example, be compounds that are converted to the gaseous state of matter with increasing temperature. As a result, both chemical and physical blowing agents are capable of creating foam structures in polymers.

The expandable material is preferably foamed thermally, using chemical blowing agents. Examples of suitable chemical blowing agents are azodicarbonamides, sulfohydrazides, hydrogencarbonates or carbonates.

Suitable blowing agents are also commercially available, for example, under the Expancel® trade name from Akzo Nobel, the Netherlands, or under the Celogen® trade name from Chemtura Corp., USA.

The heat required for the foaming can be introduced by external or by internal heat sources, such as an exothermic chemical reaction. The foamable material is preferably foamable at a temperature of ≤250° C., especially of 100° C. to 250° C., preferably of 120° C. to 240° C., preferably of 130° C. to 230° C.

Suitable expandable materials are, for example, one-component epoxy resin systems which do not flow at room temperature and in particular have elevated impact resistance and contain thixotropic agents such as aerosils or nanoclays. For example, epoxy resin systems of this type include 20% to 50% by weight of a liquid epoxy resin, 0% to 30% by weight of a solid epoxy resin, 5% to 30% by weight of impact modifiers, 1% to 5% by weight of physical or chemical blowing agents, 10% to 40% by weight of fillers, 1% to 10% by weight of thixotropic agents and 2% to 10% by weight of heat-activatable curing agents. Suitable impact modifiers are reactive liquid rubbers based on nitrile rubber or derivatives of polyether polyol polyurethanes, core-shell polymers and similar systems known to a person skilled in the art.

Likewise suitable expandable materials are one-component polyurethane compositions containing blowing agents and based on crystalline polyesters which have OH groups and have been mixed with further polyols, preferably polyether polyols, and polyisocyanates with blocked isocyanate groups. The melting point of the crystalline polyester should be ≥50° C. The isocyanate groups of the polyisocyanate may be blocked, for example, by nucleophiles such as caprolactam, phenols or benzoxalones. Also suitable are blocked polyisocyanates as used, for example, in powder-coating technology, and commercially available, for example, under the Vestagon® BF 1350 and Vestagon® BF 1540 trade names from Degussa GmbH, Germany. Suitable isocyanates are also what are called encapsulated or surface-deactivated polyisocyanates, which are known to the person skilled in the art and are described, for example, in EP 0 204 970.

Also suitable as expandable materials are two-component epoxy/polyurethane compositions which contain blowing agents, as described, for example, in WO 2005/080524 A1.

Also suitable as expandable materials are ethylene-vinyl acetate compositions containing blowing agents.

Expandable materials that are likewise suitable are sold by Sika Corp., USA, for example under the SikaBaffle® 240, SikaBaffle® 250 or SikaBaffle® 255 trade name, and are described in patents U.S. Pat. Nos. 5,266,133 and 5,373,027. Such expandable materials are particularly preferred for the present invention.

Preferred expandable materials with reinforcing properties are for example those sold by Sika Corp., USA under the SikaReinforcer® 941 trade name. These are described in U.S. Pat. No. 6,387,470.

In one illustrative embodiment, the expandable material has an expansion rate of 800% to 5000%, preferably of 1000% to 4000%, more preferably of 1500% to 3000%. Expandable materials having such expansion rates offer the advantage that it is possible thereby to achieve reliable sealing and/or insulation of the structural element with respect to liquids and sound.

In one illustrative embodiment, the expandable material is in the form of a temperature-induced material.

This has the advantage that it is possible thereby to use the furnace for baking the dip coating liquid in order to expand the expandable material and hence to insulate the cavity. Consequently, no additional working step is required.

### Carrier

The carrier may consist of any desired materials. Preferred materials are plastics, especially polyurethanes, polyamides, polyesters and polyolefins, preferably polymers which can withstand high temperatures such as poly (phenylene ethers), polysulfones or polyether sulfones, which in particular are also foamed; metals, especially aluminum and steel; or grown organic materials, especially wood materials or other (densified) fibrous materials, or vitreous or ceramic materials; especially also foamed materials of this type; or any desired combinations of these materials. Particular preference is given to using polyamide, especially nylon-6, nylon-6,6, nylon-11, nylon-12 or a mixture thereof.

Furthermore, the carrier may have any desired construction and any desired structure. It may, for example, be solid, hollow or foamed, or have a meshlike structure. Typically, the surface of the carrier may be smooth, rough or structured.

### System

The object stated at the outset is additionally achieved by a system in a motor vehicle, said system comprising: a structural element having a cavity; and an insulating element according to the description above; wherein the insulating element is disposed in the cavity of the structural element.

In one illustrative embodiment, the structural element is a portion of a column or of a beam or crossbeam of a motor vehicle body.

Details and advantages of the invention will be described hereinafter using working examples and with reference to schematic drawings. The figures show:

FIG. 1 an illustrative diagram of a vehicle body;

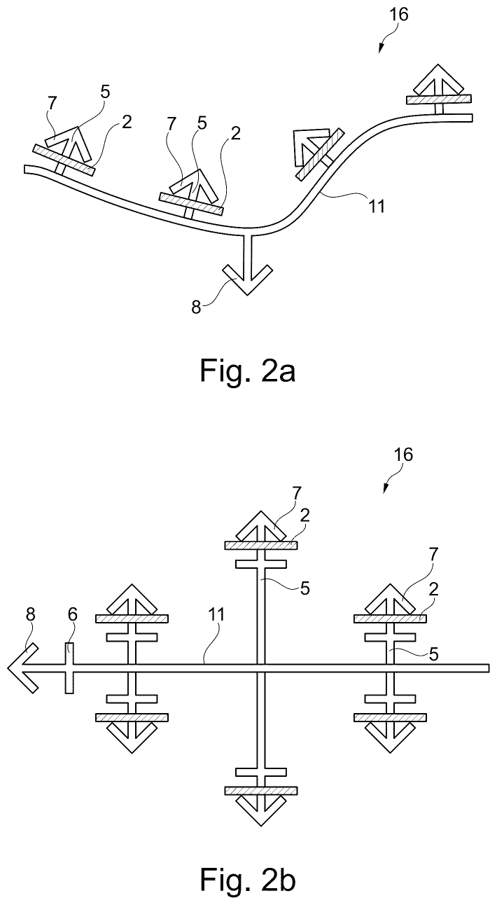

FIGS. 2a and 2b a schematic diagram of illustrative insulating elements;

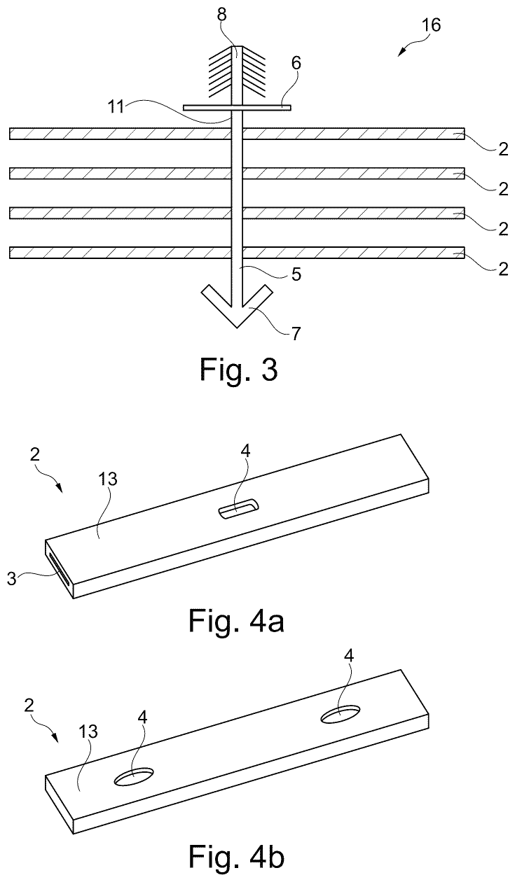

FIG. 3 a schematic diagram of an illustrative insulating element;

FIG. 4a and FIG. 4b a schematic diagram of illustrative expansion elements;

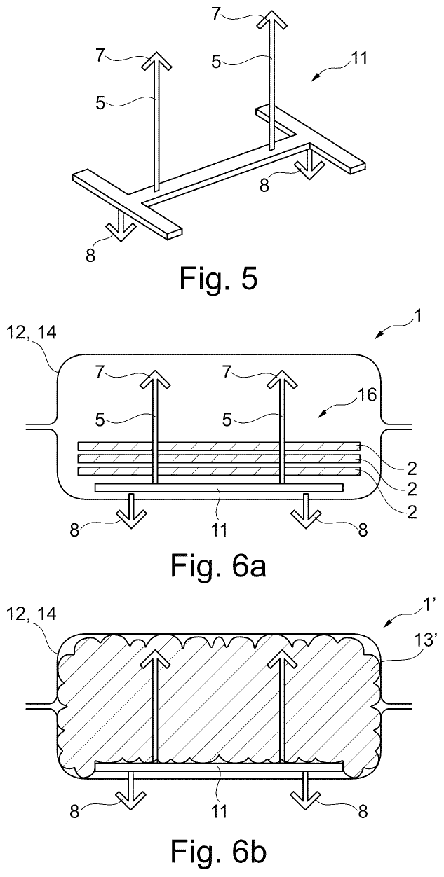

FIG. 5 a schematic diagram of an illustrative carrier; and

FIG. 6a and FIG. 6b a schematic diagram of an illustrative system.

FIGS. 2a and 2b show illustrative insulating elements 16. In both working examples, only one expansion element 2 is being mounted on each receiving element 5. The carrier 11 of the insulating element 16 comprises two or more receiving elements 5 in each case. In addition, the carrier 11 in each case comprises a fixing element 8 for fixing of the carrier 11 on a structural element (not shown). The receiving elements 5 each have a barbed hook 7 at one free end, which prevents the expansion elements 2 from falling off after the receiving element 5 has been attached/mounted. In FIG. 2b, the carrier in the region of the fixing element 8 additionally has a support foot 6, such that the carrier 11 is better supported on the structural element. In both working examples, the expansion elements 2 are each shown in a cross section at right angles to the longitudinal axis of the expansion elements.

FIG. 3c is an illustrative diagram of a further working example of an insulating element 16. This insulating element 16 again has a carrier 11 with a fixing element 8 with a support foot 6, and with an receiving element 5 with a barbed hook 7. In this working example, several expansion elements 2 are being mounted on one receiving element 5.

FIGS. 4a and 4b are illustrative diagrams of two working examples of expansion elements 2. FIG. 4a shows a first expansion element 2 having an elongated hole 4. This expansion element 2 additionally has an insert 3 disposed roughly in the middle of the expandable material 13. FIG. 4b shows a second working example of an expansion element 2. This expansion element 2 has two elongated holes 4 arranged at a particular distance from one another. In this working example, the expansion element 2 consists exclusively of expandable material 13.

FIG. 5 shows an illustrative carrier 11. In this working example, the carrier 11 has two fixing elements 8, and two receiving elements 5 with barbed hooks 7.

Finally, FIGS. 6a and 6b show a system 1 comprising a carrier 11 according to FIG. 5 and multiple expansion elements 2 according to FIG. 4b. The insulating element 16 is disposed in a structural element 12, 14. FIG. 6a shows a state prior to expansion of the expandable material 13, and FIG. 6b shows a state after an expansion, such that the expanded material 13′ is now present. By virtue of the guiding of the expansion elements 2 on the receiving elements 5, directed expansion is achieved in one plane of the receiving elements 5, such that a cross section of the structural element 12, 14 can be efficiently foamed or insulated.

### LIST OF REFERENCE NUMERALS

1 system
2 expansion element
3 insert
4 hole
5 receiving element
6 support foot
7 barbed hook
8 fixing element
10 vehicle body
11 carrier
12 structural element
13 expandable material
13′ expanded material
14 structural element
16 insulating element

1. An insulating element for insulating a structural element in a motor vehicle, the insulating element comprising:
a carrier having at least one fixing element for fixing of the carrier to the structural element and at least one receiving element; and
at least one elongated expansion element with expandable material, where the expansion element is being mounted on to the receiving element of the carrier.

2. The insulating element as claimed in claim 1, wherein the expansion element has been produced by an extrusion method.

3. The insulating element as claimed in claim 1, wherein the expansion element has been formed solely from expandable material.

4. The insulating element as claimed in claim 1, wherein the expansion element comprises an insert in the form of a foil or ribbon, wherein said insert has been covered on both sides by expandable material.

5. The insulating element as claimed in claim 1, wherein the expansion element has one or two or more than two holes.

6. The insulating element as claimed in claim 5, wherein the hole(s) has/have an elongated outline.

7. The insulating element as claimed in claim 1, wherein the expandable material has an expansion rate between 1000% and 4000%.

8. The insulating element as claimed in claim 1, wherein the carrier has one or two fixing elements.

9. The insulating element as claimed in claim 8, wherein the fixing element(s) take(s) the form of a clip or of a pushpin.

10. The insulating element as claimed in claim 1, wherein the carrier has one or two or more than two receiving elements.

11. The insulating element as claimed in claim 1, wherein the carrier has been produced by an injection molding method.

12. The insulating element as claimed in claim 1, wherein the at least one receiving element has a barbed hook at one free end.

13. The insulating element as claimed in claim 1, wherein just one expansion element is being mounted on each receiving element.

14. The insulating element as claimed in claim 1, wherein between two and eight expansion elements are being mounted on each receiving element.

15. A system in a motor vehicle, the system comprising:
a structural element having a cavity; and
an insulating element as claimed in claim 1;
wherein the insulating element is disposed in the cavity of the structural element.
